(19) United States
(12) Patent Application Publication
(10) Pub. No.: US 2026/0361220 A1
(43) Pub. Date: Nov. 12, 2026

(54) SWITCHING CONVERTER WITH IMPROVED LOAD TRANSIENT RESPONSE

(71) Applicant: Monolithic Power Systems, Inc., Kirkland, WA (US)

(72) Inventors: Qian LI, San Jose, CA (US); Cheng CHEN, Hangzhou (CN); Lijie JIANG, Hangzhou (CN)

(21) Appl. No.: 19/200,308

(22) Filed: May 6, 2025

(51) Int. Cl. H02M 3/158; H02M 1/088

(52) U.S. Cl. CPC H02M 3/1584; H02M 1/088

(57) ABSTRACT

A controller for a switching converter has a first pin to receive a load event signal, a second pin to receive a feedback signal indicative of the output voltage, and a third pin to provide a switch control signal to control a power stage based on the feedback signal and the load event signal. When the load event signal indicates that a load step-down event is about to occur to decrease a load current drawn by the load, the controller is configured to decrease the output voltage from a first voltage level to a second voltage level before the load step-down event actually occurs.

### BACKGROUND OF THE INVENTION

### 1. Field of the Invention

The present invention generally relates to electronic circuits, and more particularly but not exclusively relates to switching converters.

### 2. Description of Related Art

Switching converters, such as DC-DC converters, are employed in power supply circuits to provide a regulated output voltage to a load. A DC-DC converter may be a buck converter that converts an input voltage to a lower output voltage, a boost converter that converts the input voltage to a higher output voltage, or a buck-boost converter that is configured to perform buck or boost conversion. A load transient event occurs when the load current drawn by the load rapidly changes. For example, the load current may rapidly increase or decrease from steady state. Conventional voltage regulation control methods may not allow for fast response to adapt to rapidly changing load conditions, resulting in large output voltage undershoot or overshoot.

### SUMMARY OF THE INVENTION

It is one of the objects of the present invention to provide a switching converter and associated controller and control method of the switching converter.

One embodiment of the present invention discloses a controller for a switching converter. The controller comprises a first pin, a second pin and a third pin. The first pin is configured to receive a load event signal from a load that receives an output voltage of the switching converter. The second pin is configured to receive a feedback signal indicative of the output voltage. The third pin is configured to provide a switch control signal to control a power stage of the switching converter based on the feedback signal and the load event signal. In response to the load event signal indicating that a load step-down event is about to occur to decrease a load current drawn by the load, the controller is configured to decrease the output voltage from a first voltage level to a second voltage level which is lower than the first voltage level before the load step-down event actually occurs.

Another embodiment of the present invention discloses a switching converter. The switching converter comprises an output node, a power stage and a controller. The output node is configured to provide an output voltage to a load. The power stage has a high-side switch, a low-side switch, and an output inductor that connects the output node to a switch node formed by the high-side switch and the low-side switch. The controller is configured to receive a load event signal from the load and a feedback signal indicative of the output voltage, and configured to provide a switch control signal to control the high-side switch and the low-side switch based on the feedback signal and the load event signal. In response to the load event signal indicating that a load step-down event is about to occur, the controller is configured to decrease the output voltage from a first voltage level to a second voltage level before the load step-down event actually occurs, wherein the load step-down event is an event when a load current drawn by the load from the switching converter decreases.

Yet another embodiment of the present invention discloses a control method of a switching converter. Providing an output voltage of the switching converter. Receiving a load event signal. Detecting a plurality of voltage ranges of the load event signal. In response to the load event signal indicating that a load step-down event is about to occur, decreasing the output voltage from a first voltage level to a second voltage level before the load step-down event actually occurs. The load step-down event is an event that when a load current drawn by a load decreases.

These and other features of the present invention will be readily apparent to persons of ordinary skill in the art upon reading the entirety of this disclosure, which includes the accompanying drawings and claims.

### BRIEF DESCRIPTION OF DRAWINGS

The present invention can be further understood with reference to the following detailed description and the appended drawings, wherein like elements are provided with like reference numerals.

FIG. 1 schematically illustrates a switching converter 100 in accordance with an embodiment of the present invention.

FIG. 2 schematically illustrates a power stage 11 in accordance with an embodiment of the present invention.

FIG. 3 illustrates a load status anticipation scheme 300 of the switching converter 100 of FIG. 1 in accordance with an embodiment of the present invention.

FIG. 4 illustrates a simulation timing diagram 400 of the switching converter 100 of FIG. 1 in accordance with an embodiment of the present invention.

FIG. 5 schematically illustrates a load event detect unit 124 in accordance with an embodiment of the present invention.

FIG. 6 schematically illustrates a load event respond unit 125 in accordance with an embodiment of the present invention.

FIG. 7 schematically illustrates a switch signal generate unit 126 in accordance with an embodiment of the present invention.

FIG. 8 illustrates a load status anticipation scheme 500 of the switching converter 100 of FIG. 1 in accordance with another embodiment of the present invention.

FIG. 9 schematically illustrates a multiphase switching converter 1000 in accordance with an embodiment of the present invention.

FIG. 10 schematically illustrates a switch signal generate unit 1201 in accordance with an embodiment of the present invention.

FIG. 11 illustrates a timing diagram 110 of the multiphase switching converter 900 during load step events in accordance with an embodiment of the present invention.

FIG. 12 illustrates a prior art timing diagram 120 of a multiphase switching converter during load step events.

FIG. 13 illustrates a control method 130 for a switching converter in accordance with an embodiment of the present invention.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

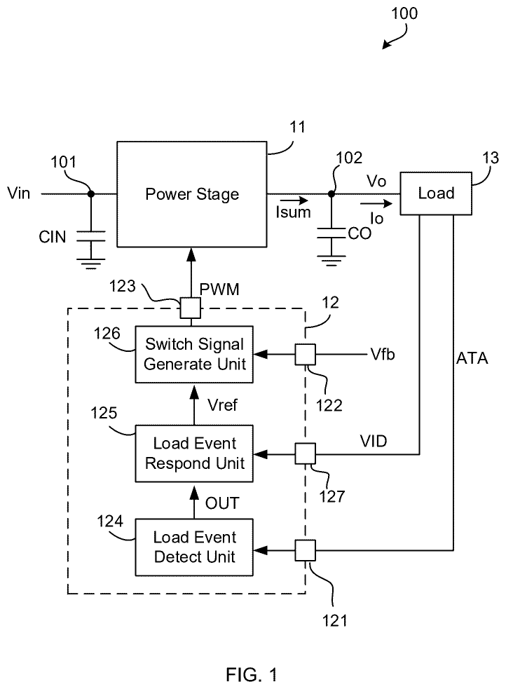

FIG. 1 schematically illustrates a switching converter 100 in accordance with an embodiment of the present invention. The switching converter 100 has an input node 101 to receive a DC input voltage Vin across an input capacitor CIN, and an output node 102 to provide a regulated DC output voltage Vo across an output capacitor CO to a load 13. The load 13 is external to the switching converter 100 and draws a load current Io from the switching converter 100. The input capacitor CIN is electrically connected between the input node 101 and a reference ground, and the output capacitor CO is electrically connected between the output node 102 and the reference ground.

The switching converter 100 further has a power stage 11 and a controller 12. The power stage 11 may comprise a buck circuit, a boost circuit, or other suitable circuit, with single phase or multiphase. The controller 12 may be integrated in an integrated circuit (IC) chip, and has a pin 121 to receive a load event signal ATA from the load 13, a pin 122 configured to receive a feedback signal Vfb indicative of the output voltage Vo, a pin 123 configured to provide a switch control signal PWM to control the power stage 11, e.g., turn ON and turn OFF at least one switch of the power stage 11, in response to the feedback signal Vfb and the load event signal ATA, to regulate the output voltage Vo.

In one embodiment, in response to the load event signal ATA indicating that a load step-down event is about to occur, the output voltage Vo is regulated to decrease from a voltage level V1 to a voltage level V3 and a total current Isum provided by the switching converter 100 decreases before the load step-down event actually occurs. The load step-down event is an event when the load current Io drawn by the load 13 from the switching converter 100 decreases. In one embodiment, in response to the load event signal ATA indicating that a load step-up event is about to occur, the output voltage Vo is regulated to increase from the voltage level V1 to a voltage level V2 and the total current Isum provided by the switching converter 100 increases before the load step-up event actually occurs. The load step-up event is an event when the load current Io drawn by the load 13 from the switching converter 100 increases.

A load event detect unit 124 of FIG. 1 detects the load event signal ATA and recognizes the upcoming load step-down event, the upcoming load step-up event, and a load step size. The load step size indicates a degree of variation in the load current Io(e.g., increasing for load step-up event and decreasing for load step-down event) over a time period, e.g., to scale from a step of the load current Io, as percentage. The load step size definition could be different from different loads (e.g., ASIC or SOC chips). It is up to specific ASIC/SOC behavior to define it. The load event detect unit 124 provides an indication signal OUT based on the load event signal ATA. A load event respond unit 125 provides a reference voltage Vref based on the indication signal OUT and a data (e.g., a voltage identification code VID provided by the load 13 as shown in FIG. 1) which is used to control a setpoint of the output voltage Vo. The controller 12 has a pin 127 coupled to a communication bus to receive the data, e.g., from the load 13 or from a host. In one embodiment, the voltage level V1 is determined by the data. In another embodiment, the voltage level V1 is further determined by the load current Io, e.g., the load current Io accounts for adding a droop on the output voltage Vo. When the load event signal ATA indicates that the load step-down event is about to occur, the load event respond unit 125 decreases the reference voltage Vref. When the load event signal ATA indicates that the load step-up event is about to occur, the load event respond unit 125 increases the reference voltage Vref. When the load event signal ATA indicates that the load step-up/step-down event actually occurs, the load event respond unit 125 resumes the reference voltage Vref to regulate the output voltage Vo back to the voltage level V1. A switch signal generate unit 126 generates the switch control signal PWM based on the output voltage Vo and the reference voltage Vref, e.g., via comparing the feedback signal Vfb with the reference voltage Vref.

The load 13 may be a central processing unit (CPU) chip, a graphics processing unit (GPU) chip, an application specific integrated circuit (ASIC) chip, a system-on-chip (SOC) chip, an (artificial intelligence) AI system, a power management circuit, or other circuit that provides the load event signal ATA as an early warning to indicate an upcoming load transient. For example, the load 13 may send the load event signal ATA before and after it performs extensive computation. Furthermore, the controller 12 could recognize a plurality of voltage ranges of the load event signal ATA to indicate different types and indensities of the load transients. This gives the controller 12 adequate time to prepare for and respond to the load transients, which improves the load transient performance, helps reduce the output capacitance for cost and size optimization, and also enables the load 13 to achieve higher performance per watt.

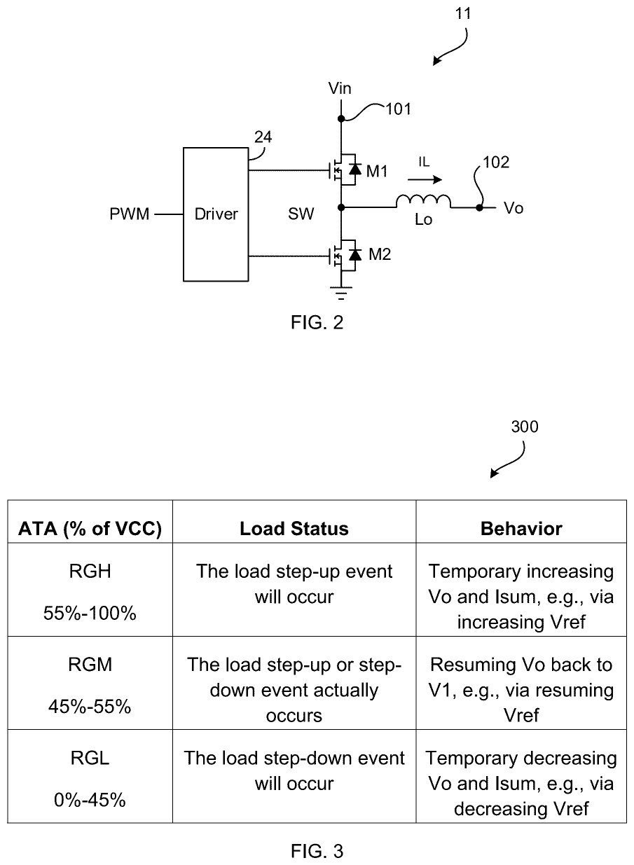

FIG. 2 schematically illustrates the power stage 11 in accordance with an embodiment of the present invention. In the example of FIG. 2, the power stage 11 is a BUCK DC-DC converter. As can be appreciated, embodiments of the present invention are equally applicable to other types of power converters. The power stage 11 is coupled between the input node 101 and the output node 102, to receive the input voltage Vin and generate the regulated output voltage Vo. In the example of FIG. 2, the power stage 11 has one phase circuit. In other examples, the power stage 11 may have more than one phase circuit.

As shown in FIG. 2, the power stage 11 has a high-side switch M1 and a low-side switch M2 coupled in series between the input node 101 and the reference ground. A switch node SW is formed by the high-side switch M1 and the low-side switch M2. The high-side switch M1 and the low-side switch M2 may comprise Bipolar Junction Transistor (BJT), Metal Oxide Semiconductor Field Effect Transistor (MOSFET), and other suitable transistors. In one embodiment, each of the high-side switch M1 and the low-side switch M2 has a first terminal (e.g., drain), a second terminal (e.g. source), and a control terminal (e.g., gate). The first terminal of the high-side switch M1 is coupled to the input node 101, the second terminal of the high-side switch M1 is coupled to the first terminal of the low-side switch M2 to form the switch node SW, and the second terminal of the low-side switch M2 is coupled to the reference ground GND. An inductor Lo is coupled between the switch node SW and the output node 102. A current IL flows through the inductor Lo.

A driver 24 is configured to drive the high-side switch M1 and the low-side switch M2 based on the switch control signal PWM, e.g., in the form of a pulse width modulation signal. When in normal operation, the high-side switch M1 and the low side power switch M2 are turned on alternately. For example, the low-side switch M2 is OFF while the high-side switch M1 is ON, and the high-side switch M1 is OFF while the low-side switch M2 is ON. When the high-side switch M1 is ON and the low-side switch M2 is OFF, the power stage 11 is turned ON, and the switch node SW electrically connects to the input node 101 via the high-side switch M1. When the low-side switch M2 is ON and the high-side switch M1 is OFF, the power stage 11 is turned OFF, and the switch node SW electrically connects to the reference ground via the low-side switch M2.

The controller 12 shown in FIG. 1 provides the switch control signal PWM to control the high-side switch M1 and the low-side switch M2 via the driver 24 to regulate the output voltage Vo. Turning ON the switch control signal PWM means to turn ON the high-side switch M1 and thus the power stage 11, and turning OFF the switch control signal PWM means to turn OFF the high-side switch M1 and thus the power stage 11. In one embodiment, the PWM signal is in the ON state when at a logical HIGH and in the OFF state when at a logical LOW. In some examples, a voltage level between a high threshold voltage (e.g. 2V) and a voltage source VCC (e.g. 3.3V) is considered as the logical HIGH, a voltage level between zero voltage (0 V) and a low threshold voltage (e.g. 1V) is considered as the logical LOW.

FIG. 3 illustrates a load status anticipation scheme 300 in accordance with an embodiment of the present invention. The load status anticipation scheme 300 shows an example of the load status detection and response conducted by the controller 12. In one embodiment, the controller 12 is configured to recognize a plurality of voltage ranges of the load event signal ATA to determine the load status. The load status comprises that the load step-down event is about to occur, the load step-up event is about to occur, and at least one of the load step-down event and the load step-up event actually occurs. In one example, the load event signal ATA is an analog signal, different voltage range of the load event signal ATA indicates different load step events.

In the example of FIG. 3, a voltage range RGH (e.g., 55%-100% VCC) of the load event signal ATA indicates that the load step-up event will occur, a voltage range RGL (e.g., 0%-45% VCC) of the load event signal ATA indicates that the load step-down event will occur, and a voltage range RGM (e.g., 45%-55% VCC) of load event signal ATA indicates that the load step-up or step-down event actually occurs. The controller 12 is configured to recognize the load status via detecting the voltage range of the load event signal ATA. In response to the voltage range RGH of the load event signal ATA, the switching converter 100 temporary increases the output voltage Vo and the total current Isum before the load step-up events actually occurs, e.g., via increasing the reference voltage Vref. In response to the voltage range RGL of the load event signal ATA, the switching converter 100 temporary decreases the output voltage Vo and the total current Isum before the load step-up events actually occurs, e.g., via decreasing the reference voltage Vref. In response to the voltage range RGM of the load event signal ATA, the switching converter 100 resumes the output voltage Vo back to the voltage level V1, e.g., via resuming the reference voltage Vref. In one embodiment, the load event detect unit 124 is employed to identify which voltage range the load event signal ATA is in.

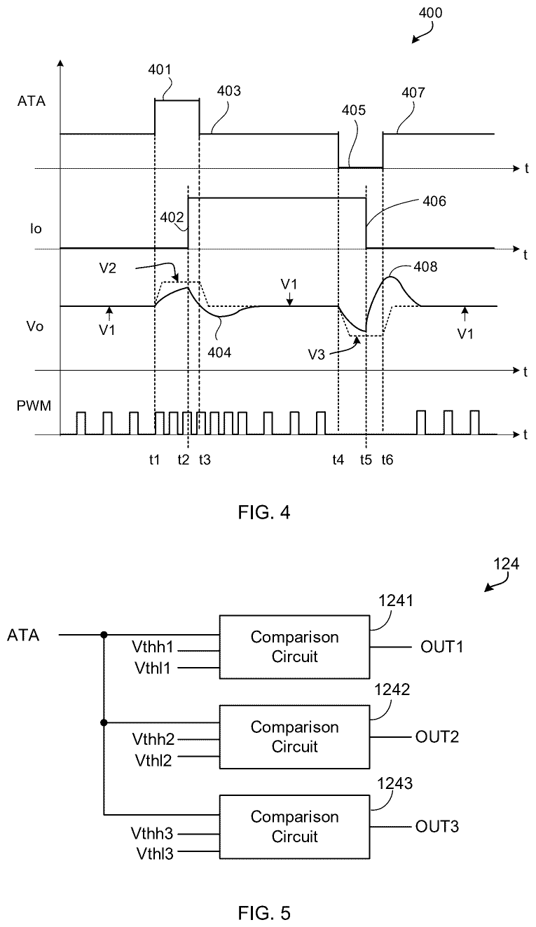

FIG. 4 illustrates a timing diagram 400 of the switching converter 100 of FIG. 1 in accordance with an embodiment of the present invention. FIG. 4 shows, from top to bottom, the load event signal ATA from the load 13 shown in FIG. 1, the load current Io drawn by the load 13, the output voltage Vo, and the switch control signal PWM.

At time t1, the load event signal ATA transitions to the voltage range RGH (see FIGS. 4, 401), to indicate that the load step-up event is coming. It is to be noted that the load 13 provides the load event signal ATA as an early warning before the load step-up event actually occurs, This can be seen in FIG. 4 that the load current Io does not step-up until time t2 (see FIGS. 4, 402). The time between the load event signal ATA indicating that the load step-up event is coming at time t1 and the actually load step-up at time t2 depends on the application. At time t1, in response to the load event signal ATA indicating that the step-up event is about to occur, the controller 12 starts to regulate the output voltage Vo from the voltage level V1 to the voltage level V2, e.g., via increasing the reference voltage Vref which represents a voltage that the output voltage is aimed to be regulated to. The controller 12 asserts (i.e., generate as a logical HIGH) the switch control signal PWM with its switching frequency increasing.

At time t2, the load step-up event actually starts (see FIGS. 4, 402), and the output voltage Vo starts to decrease. At time t3, the load event signal ATA resumes to the voltage range RGM (see FIGS. 4, 403) to indicate that the load step-up event actually occurs, then the reference voltage Vref resumes and the controller 12 aims to regulate the output voltage Vo back to the voltage level V1. After a relatively small undersoot (see FIGS. 4, 404), the output voltage Vo increases back up to the voltage level V1.

At time t4, the load event signal ATA transitions to the voltage range RGL (see FIGS. 4, 405), to indicate that the load step-down event is coming. It is to be noted that the load 13 provides the load event signal ATA as an early warning before the load step-down event actually occurs, This can be seen in FIG. 4 that the load current Io does not step-down until time t5 (see FIGS. 4, 406). The time between the load event signal ATA indicating that the load step-down event is coming at time t4 and the actually load step-down at time t5 depends on the application. At time t4, in response to the load event signal ATA indicating that the step-down event is about to occur, the controller 12 starts to regulate the output voltage Vo from the voltage level V1 to the voltage level V3, e.g., via decreasing the reference voltage Vref. The controller 12 asserts (i.e., generate as a logical HIGH) the switch control signal PWM with its switching frequency decreasing.

At time t5, the load step-down event actually starts (see FIGS. 4, 406), and the output voltage Vo starts to increase. At time t6, the load event signal ATA resumes to the voltage range RGM (see FIGS. 4, 407) to indicate that the load step-down event actually occurs, then the reference voltage Vref resumes and the controller 12 aims to regulate the output voltage Vo back to the voltage level V1. After a relatively small oversoot (see FIGS. 4, 408), the output voltage Vo decreases back down to the voltage level V1. In the example of FIG. 4, after the load event signal ATA indicates that the load step-down event is coming at time t4, the switch control signal PWM remains logical LOW since the reference voltage Vref is decreased and the output voltage Vo is higher than the reference voltage Vref. The switch control signal PWM resumes turning ON and turning OFF the power stage 11 once the output voltage Vo decreases back to the voltage level V1.

FIG. 5 schematically illustrates the load event detect unit 124 in accordance with an embodiment of the present invention. In the example of FIG. 5, the indication signal OUT comprises signals OUT1-OUT3. In other examples, the indication signal OUT could comprises more or less signals. The load event detect unit 124 detects the load event signal ATA, and provides the indication signal OUT (e.g., OUT1-OUT3 shown in FIG. 5) to indicate the voltage range that the load event signal ATA is in.

As shown in FIG. 5, the load event signal ATA is compared to thresholds Vthh1 and Vthl1 via a comparison circuit 1241. When the load event signal ATA is in a voltage range between the thresholds Vthl1 and Vthh1, the indication signal OUT1 is asserted (e.g., be logical HIGH), otherwise when the load event signal ATA is out of the voltage range between the thresholds Vthl1 and Vthh1, the indication signal OUT1 is de-asserted (e.g., be logical LOW). For example, the threshold Vthl1 is 45% VCC, and the threshold Vthh1 is 55% VCC, and the indication signal OUT1 is asserted to indicate that the load event signal ATA is in the voltage range RGM. The load event signal ATA is compared to thresholds Vthh2 and Vthl2 via a comparison circuit 1242. When the load event signal ATA is in a voltage range between the thresholds Vthl2 and Vthh2, the indication signal OUT2 is asserted (e.g., be logical HIGH), otherwise when the load event signal ATA is out of the voltage range between the thresholds Vthl2 and Vthh2, the indication signal OUT2 is de-asserted (e.g., be logical LOW). For example, the threshold Vthl2 is 0% VCC, and the threshold Vthh2 is 45% VCC, and the indication signal OUT2 is asserted to indicate that the load event signal ATA is in the voltage range RGL. The load event signal ATA is compared to thresholds Vthh3 and Vthl3 via a comparison circuit 1243. When the load event signal ATA is in a voltage range between the thresholds Vthl3 and Vthh3, the indication signal OUT3 is asserted (e.g., be logical HIGH), otherwise when the load event signal ATA is out of the voltage range between the thresholds Vthl3 and Vthh3, the indication signal OUT3 is de-asserted (e.g., be logical LOW). For example, the threshold Vthl3 is 55% VCC, and the threshold Vthh3 is 100% VCC, and the indication signal OUT3 is asserted to indicate that the load event signal ATA is in the voltage range RGH.

FIG. 5 has three comparison circuits 1241-1243 to detect the load event signal ATA's voltage range. However, more or less comparison circuits will be used to identify more or less voltage range of the load event signal ATA, depends on different applications.

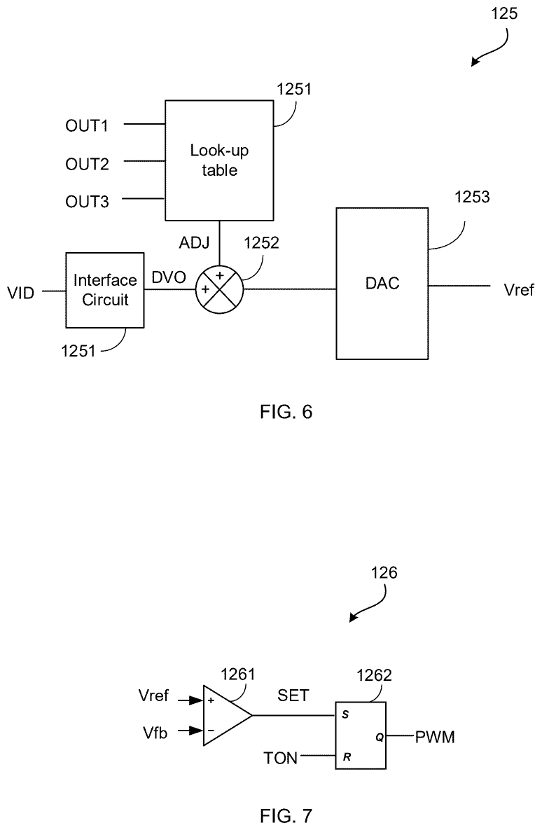

FIG. 6 schematically illustrates a load event respond unit 125 in accordance with an embodiment of the present invention. As shown in FIG. 6, an interface circuit 1251 receives the data VID, and provides a signal DVO based on the data VID, to control the voltage level V1 of the output voltage Vo. A look-up table 1251 is employed to provide an adjust value ADJ based on the indication signal OUT (e.g., OUT1-OUT3). When the indication signal OUT1 is logical HIGH, the adjust value ADJ is given to a first data, e.g., corresponding to 0V, to maintain the output voltage Vo at the voltage level V1. When the indication signal OUT2 is logical HIGH, the adjust value ADJ is given to a second data, e.g., corresponding to a negative voltage bias, to decrease the output voltage Vo from the voltage level V1. When the indication signal OUT3 is logical HIGH, the adjust value ADJ is given to a third data, e.g., corresponding to a positive voltage bias, to increase the output voltage Vo from the voltage level V1. The adjust value ADJ and the signal DVO are added together via an operator 1252. A digital to analog converter (DAC) 1253 is employed to convert the sum of the adjust value ADJ and the signal DVO (ADJ+DVO) to the reference voltage Vref.

FIG. 7 schematically illustrates a switch signal generate unit 126 in accordance with an embodiment of the present invention. As shown in FIG. 7. the switch signal generate unit 126 has a comparison circuit 1261 and a logic circuit 1262 (e.g., a RS flip-flop). The comparison circuit 1261 receives the feedback signal Vfb and the reference voltage Vref, and provides a set signal SET via comparing the feedback signal Vfb with the reference voltage Vref. The logic circuit 1262 is coupled to the comparison circuit 1261 to receive the set signal SET (e.g., at a set terminal “S” of the RS flip-flop). The logic circuit 1262 further receives an ON-time signal TON (e.g., at a reset terminal “R” of the RS flip-flop), and provides the switch control signal PWM (e.g., at an output terminal “Q” of the RS flip-flop) based on the set signal SET and the ON-time signal TON. In one embodiment, the switch control signal PWM is set to logical HIGH to turn on the power stage 11 in response to the feedback signal Vfb being less than the reference voltage Vref, and reset to logical LOW to turn off the power stage 11 in response to the ON-time signal TON.

In the example of FIG. 7, the switch signal generate unit 126 employs a constant ON-time control to regulate the output voltage, however, other control could be adopted, such as peak current control, hysterisis control, and so on.

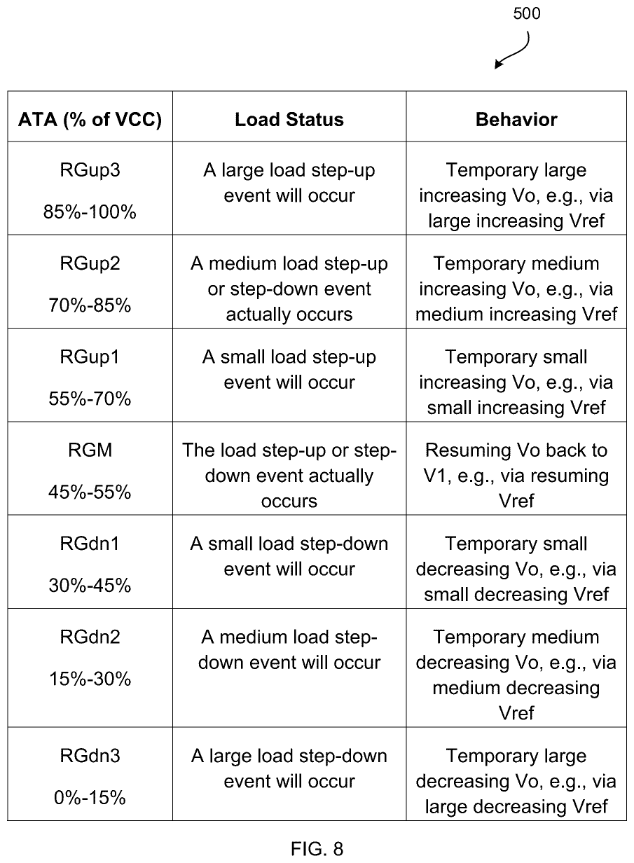

FIG. 8 illustrates a load status anticipation scheme 500 in accordance with another embodiment of the present invention. The load status anticipation scheme 500 shows another example of the load status detection and response conducted by the controller 12. In one embodiment, the controller 12 is configured to recognize a plurality of voltage ranges of the load event signal ATA to determine the upcoming load step-up event, the upcoming load step-down event, and the load step size.

In one embodiment, in response to the load step size of the upcoming load step-up event, the controller 12 is configured to adjust the voltage level V2 that the output voltage Vo increases to. For example, for the upcoming load step-up event with a larger degree of increasing in the load current Io, the voltage level V2 is higher and the controller 12 is configured to increase the output voltage Vo more; and for the load step-up event with a small degree of increasing in the load current Io, the voltage level V2 is lower and the controller 12 is configured to increase the output voltage Vo less.

In the example of FIG. 8, a voltage range RGup1 (e.g., 55%~70% VCC) of the dload event signal ATA indicates that a small load step-up event will occur. In response to the voltage range RGup1 of the load event signal ATA, the switching converter 100 temporary small increases the output voltage Vo, e.g., via small increasing the reference voltage Vref with 50 mV. A voltage range RGup2 (e.g., 70%~85% VCC) of the load event signal ATA indicates that a medium load step-up event will occur. In response to the voltage range RGup2 of the load event signal ATA, the switching converter 100 temporary medium increases the output voltage Vo, e.g., via medium increasing the reference voltage Vref with 100 mV. A voltage range RGup3 (e.g., 85%~100% VCC) of the load event signal ATA indicates that a large load step-up event will occur. In response to the voltage range RGup3 of the load event signal ATA, the switching converter 100 temporary large increases the output voltage Vo, e.g., via large increasing the reference voltage Vref with 150 mV.

In one embodiment, in response to the load step size of the upcoming load step-down event, the controller 12 is configured to adjust the voltage level V3 that the output voltage Vo decreases to. For example, for the load step-down event with a larger degree of decreasing in the load current Io, the voltage level V3 is lower and the controller 12 is configured to decrease the output voltage Vo more; and for the load step-down event with a small degree of decreasing in the load current Io, the voltage level V3 is higher and the controller 12 is configured to decrease the output voltage Vo less.

In the example of FIG. 8, a voltage range RGdn1 (e.g., 30%~45% VCC) of the dload event signal ATA indicates that a small load step-down event will occur. In response to the voltage range RGdn1 of the load event signal ATA, the switching converter 100 temporary small decreases the output voltage Vo, e.g., via small decreasing the reference voltage Vref with 50 mV. A voltage range RGdn2 (e.g., 15%~30% VCC) of the load event signal ATA indicates that a medium load step-up event will occur. In response to the voltage range RGdn2 of the load event signal ATA, the switching converter 100 temporary medium decreases the output voltage Vo, e.g., via medium decreasing the reference voltage Vref with 100 mV. A voltage range RGdn3 (e.g., 0%~15% VCC) of the load event signal ATA indicates that a large load step-up event will occur. In response to the voltage range RGdn3 of the load event signal ATA, the switching converter 100 temporary large decreases the output voltage Vo, e.g., via large decreasing the reference voltage Vref with 150 mV.

In the example of FIG. 8, the voltage range RGM (e.g., 45%-55% VCC) of the load event signal ATA indicates that the load step-up or step-down event actually occurs. In response to the voltage range RGM of the load event signal ATA, the switching converter 100 resumes the output voltage Vo back to the voltage level V1, e.g., via resuming the reference voltage Vref.

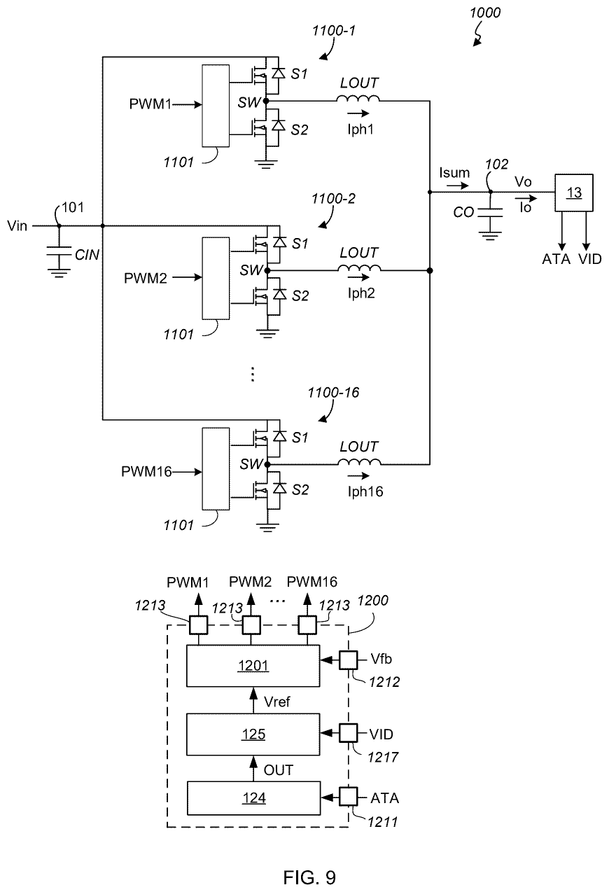

FIG. 9 schematically illustrates a multiphase switching converter 1000 in accordance with an embodiment of the present invention. A power stage of the multiphase switching converter 1000 is formed by 16 phases as one example. The power stage of the multiphase switching converter 100 is not limited by 16 phases shown in FIG. 9.

Each phase 1100 (i.e., 1100-1, 1100-2 . . . 1100-16) has a high-side switch S1, a low-side switch S2, a driver 1101, and an output inductor LOUT. The switches S1 and S2 may be metal-oxide-semiconductor field effect transistors (MOSFETs) or other types of transistors. The driver 1101 receives the switch control signal PWM (i.e., PWM1 for phase 1100-1, PWM2 for phase 1100-2 . . . PWM16 for phase 1100-16), and drives the high-side switch S1 and the low-side switch S2 based on the switch control signal PWM. The output inductor LOUT has a first end that is connected to the switch node SW formed by the high-side switch S1 and the low-side switch S2. A second end of the output inductor LOUT is connected to the output node 102 to provide the output voltage Vo to the load 13. When the high-side switch S1 is ON and the low-side switch S2 is OFF, the phase 1100 is ON and the high-side switch S1 connects the input voltage Vin to the load 13 by way of the output inductor LOUT. When the low-side switch S2 is ON and the high-side switch S1 is OFF, the phase 1100 is OFF and the low-side switch S2 connects the load 13 to the reference ground by way of the output inductor LOUT.

The controller 1200 is configured to control the operation of phases 1100 of the multiphase switching converter 1000. The controller 1200 has a pin 1211 configured to receive the load event signal ATA from the load 13, a pin 1212 configured to receive the feedback signal Vfb indicative of the output voltage Vo, a plurality of pins 1213 configured to provide the switch control signals PWM (i.e., PWM1, PWM2, . . . PWM16). In one embodiment, the controller 1200 is implemented as an IC chip. The controller 1200 provides the switch control signals PWM based on the feedback signal Vfb indicative of the output voltage Vo and the load step event signal ATA to control the phases 1100, so as to regulate the output voltage Vo. Turning ON/OFF one switch control signal PWM turns ON/OFF the corresponding high-side switch S1 and thus the corresponding phase 1100.

The controller 1200 has the load event detect unit 124, the load respond unit 125 and a switch signal generate unit 1201. The load event detect unit 124 and the load respond unit 125 are same as shown in FIG. 1, and will not be described here for clarity. The switch signal generate unit 1201 generates the switch control signals PWM based on the output voltage Vo and the reference voltage Vref, e.g., via comparing the feedback signal Vfb with the reference voltage Vref. The controller 1200 further has a pin 1217 coupled to a communication bus to receive the data (e.g., VID from the load 13).

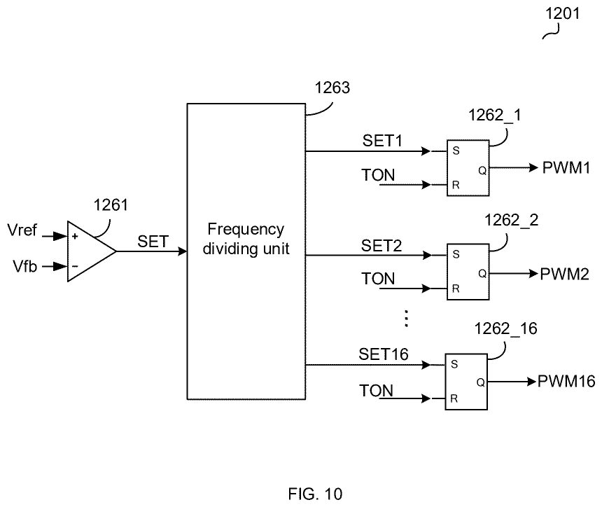

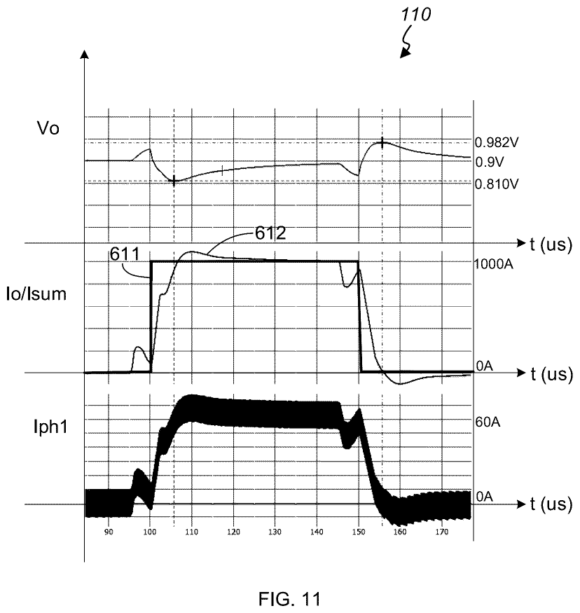

FIG. 10 schematically illustrates the switch signal generate unit 1201 in accordance with an embodiment of the present invention. As shown in FIG. 10. the switch signal generate unit 1201 has the comparison circuit 1261, a frequency dividing unit 1263, and logic circuits 1262 (i.e., 1262-1, 1262-2, . . . 1262-16). Logic circuits 1262 may comprise a RS flip-flop as one example. The comparison circuit 1261 receives the feedback signal Vfb and the reference voltage Vref, and provides the set signal SET via comparing the feedback signal Vfb with the reference voltage Vref. The frequency dividing unit 1263 receives the set signal SET and provides a plurality of sub-control signals SET1, SET2, . . . SET16 based on the set signal SET, e. g, via distributing pulses of the set signal SET to the sub-control signals SET1-SET16 successively. Each logic circuit 1262 receives corresponding sub-control signal and the ON-time signal TON, and provides the switch control signal PWM. For example, the logic circuit 1262-1 receives the sub-control signal SET1 and the ON-time control signal TON, and provides the switch control signal PWM1 based on the sub-control signal SET1 and the ON-time control signal TON, the logic circuit 1262-2 receives the sub-control signal SET2 and the ON-time control signal TON, and provides the switch control signal PWM2 based on the sub-control signal SET2 and the ON-time control signal TON, and the logic circuit 1262-16 receives the sub-control signal SET16 and the ON-time control signal TON, and provides the switch control signal PWM16 based on the sub-control signal SET16 and the ON-time control signal TON.

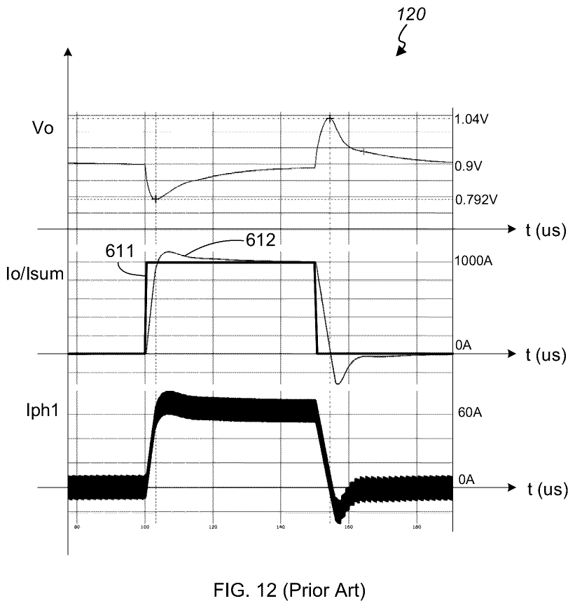

FIG. 11 illustrates a timing diagram 110 of the multiphase switching converter 900 in accordance with an embodiment of the present invention. FIG. 12 illustrates a prior art timing diagram 120 of a multiphase switching converter. From top to bottom, the timing diagrams 110 and 120 respectively show the output voltage Vo, the load current Io (see FIGS. 11-12, 611), the total current Isum (see FIGS. 11-12, 612), a phase current Iph1 provided by the phase 1100-1. The total current Isum is all the inductor current of each phase added together(Iph1+Iph2+. . . +Iph16). In the example of FIG. 11, the input voltage Vin is 12V, the setpoint of the output voltage Vo is 0.9V, the load step-up event is from 0 A to 1000 A, with 2000 A/us slew rate. The load step-down event is from 1000 A to 0 A, with 2000 A/us slew rate.

As shown in FIG. 11, when the load current Io is about to step-up (the load step-up event is upcoming), the output voltage Vo and the total current Isum slightly increases before the load current Io actually steps up. After the load step-up event actually occurs, the output voltage Vo decreases first to an undershoot and then resumes to 0.9V. The undershoot of the output voltage Vo shown in FIG. 11 is 0.810V and the undershoot of the output voltage Vo shown in FIG. 12 is 0.792V, that is the negative variation of the output voltage Vo in response to the load step-up event is reduced in accordance with an embodiment of the present invention.

As shown in FIG. 11, when the load current Io is about to step-down (the load step-down event is upcoming), the output voltage Vo and the total current Isum slightly decreases before the load current Io actually steps down. After the load step-down event actually occurs, the output voltage Vo increases first to an overshoot and then resumes back to the default value of the output voltage Vo. The overshoot of the output voltage Vo shown in FIG. 11 is 0.982V, and the overshoot of the output voltage Vo shown in FIG. 12 is 1.04V, that is the positive variation of the output voltage Vo in response to the load step-down event is reduced in accordance with an embodiment of the present invention.

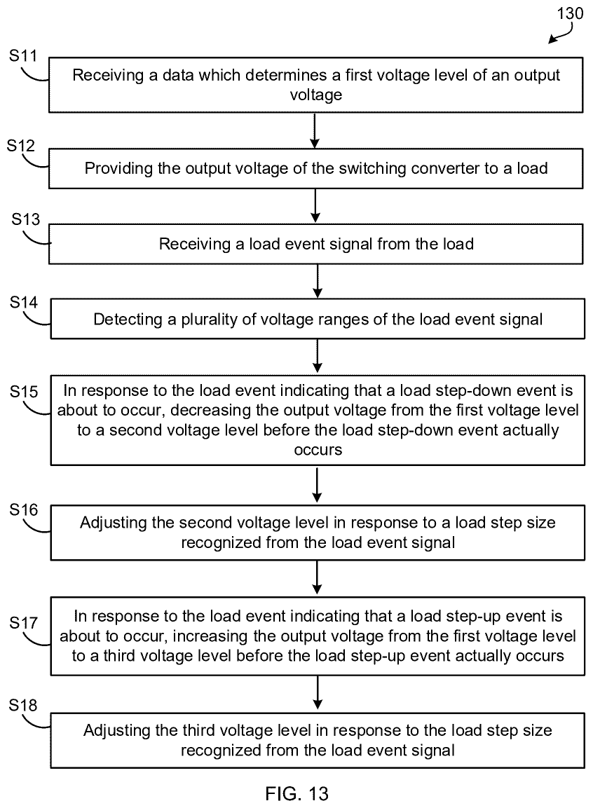

FIG. 13 illustrates a control method 130 for a switching converter in accordance with an embodiment of the present invention. The control method 130 comprises steps S11-S18.

At step S11, receiving a data which determines a first voltage level of an output voltage of the switching converter.

At step S12, providing the output voltage of the switching converter to a load.

At step S13, receiving a load event signal from the load.

At step S14, detecting a plurality of voltage ranges of the load event signal.

At step S15, in response to the load event signal indicating that the load step-down event is about to occur, decreasing the output voltage from the first voltage level to a second voltage level before the load step-down event actually occurs.

At step S16, adjusting the second voltage level in response to a load step size recognized from the load event signal.

At step S17, in response to the load event signal indicating that the load step-up event is about to occur, increasing the output voltage from the first voltage level to a third voltage level before the load step-up event actually occurs.

At step S18, adjusting the third voltage level in response to the load step size recognized from the load event signal.

In one embodiment, the control method 130 further comprises generating a reference voltage based on the data and the load event signal, wherein the reference voltage is decreased in response to the load event signal indicating that the load step-down event is about to occur, and the reference voltage is increased in response to that load event signal indicating that the load step-up event is about to occur.

Note that in the flow chart described above, the box functions may also be implemented with different order as shown in FIG. 13. Two successive box functions may be executed meanwhile, or sometimes the box functions may be executed in a reverse order.

Obviously many modifications and variations of the present invention are possible in light of the above teachings. It is therefore to be understood that within the scope of the appended claims the invention may be practiced otherwise than as specifically described. It should be understood, of course, the foregoing disclosure relates only to a preferred embodiment (or embodiments) of the invention and that numerous modifications may be made therein without departing from the spirit and the scope of the invention as set forth in the appended claims. Various modifications are contemplated and they obviously will be resorted to by those skilled in the art without departing from the spirit and the scope of the invention as hereinafter defined by the appended claims as only a preferred embodiment(s) thereof has been disclosed.

I/We claim:

1. A controller for a switching converter, comprising:
a first pin configured to receive a load event signal from a load that receives an output voltage of the switching converter;
a second pin configured to receive a feedback signal indicative of the output voltage; and
a third pin configured to provide a switch control signal to control a power stage of the switching converter based on the feedback signal and the load event signal; wherein
in response to the load event signal indicating that a load step-down event is about to occur to decrease a load current drawn by the load, the controller is configured to decrease the output voltage from a first voltage level to a second voltage level which is lower than the first voltage level before the load step-down event actually occurs.

2. The controller of claim 1, wherein in response to the load event signal indicating that the load step-down event actually occurs, the controller is configured to increase the output voltage from the second voltage level, and then resume the output voltage back to the first voltage level.

3. The controller of claim 1, wherein the controller is configured to determine that the load step-down event is about to occur in response to a first voltage range of the load event signal, and the controller is configured to determine that the load step-down event actually occurs in response to that the load event signal transitions to a second voltage range from the first voltage range.

4. The controller of claim 3, wherein the controller is configured to determine that a load step-up event is about to occur in response to a third voltage range of the load event signal, and the controller is configured to determine that the load step-up event actually occurs in response to that the load event signal transitions to a second voltage range from the third voltage range.

5. The controller of claim 1, wherein the controller is configured to recognize a plurality of voltage ranges of the load event signal to determine a load status, wherein the load status comprises that the load step-down event is about to occur, a load step-up event is about to occur, and one of the load step-down event and the load step-up event actually occurs.

6. The controller of claim 1, wherein:
in response to the load event signal indicating that a load step-up event is about to occur to increase the load current drawn by the load, the controller is configured to increase the output voltage from the first voltage level to a third voltage level which is higher than the first voltage level and increase a total current provided by the switching converter before the load step-up event actually occurs; and
in response to the load event signal indicating that the load step-up event actually occurs, the controller is configured to decrease the output voltage from the third voltage level, and then resume the output voltage back to the first voltage level.

7. The controller of claim 1, further comprising:
a load event detect unit configured to detect the load event signal and recognize the load step-down event and a load step size, wherein the load step size indicates a degree of variation in the load current drawn by the load over a time period; wherein
the controller is configured to adjust the second voltage level in response to the load step size.

8. The controller of claim 1, further comprising:
a load event detect unit configured to detect the load event signal and recognize a load step-up event and a load step size, wherein the load step size indicates a degree of variation in the load current drawn by the load over a time period.

9. The controller of claim 8, wherein in response to the load event signal indicating that the load step-up event is about to occur to increase the load current drawn by the load, the controller is configured to increase the output voltage from the first voltage level to a third voltage level which is higher than the first voltage level before the load step-up event actually occurs, and the controller is configured to adjust the third voltage level in response to the load step size.

10. The controller of claim 1, further comprising:
a switch signal generate unit configured to provide the switching control signal based on the feedback signal and a reference voltage; and
a load event respond unit configured to provide the reference voltage based on the load event signal and a setpoint of the output voltage.

11. A switching converter, comprising:
an output node configured to provide an output voltage to a load;
a power stage having a high-side switch, a low-side switch, and an output inductor that connects the output node to a switch node formed by the high-side switch and the low-side switch; and
a controller configured to receive a load event signal from the load and a feedback signal indicative of the output voltage, and configured to provide a switch control signal to control the high-side switch and the low-side switch based on the feedback signal and the load event signal; wherein
in response to the load event signal indicating that a load step-down event is about to occur, the controller is configured to decrease the output voltage from a first voltage level to a second voltage level before the load step-down event actually occurs, wherein the load step-down event is an event when a load current drawn by the load from the switching converter decreases.

12. The switching converter of claim 11, wherein the controller is configured to detect the load event signal and recognize the load step-down event and a load step size, wherein the load step size indicates a degree of variation in the load current drawn by the load over a time period.

13. The switching controller of claim 12, wherein the controller is configured to adjust the second voltage level in response to the load step size.

14. The switching converter of claim 11, wherein:
the controller is configured to detect the load event signal and recognize a load step-up event and a load step size, wherein the load step size indicates a degree of variation in the load current drawn by the load over a time period.

15. The switching converter of claim 14, wherein in response to the load event signal indicating that the load step-up event is about to occur to increase the load current drawn by the load, the controller is configured to increase the output voltage from the first voltage level to a third voltage level before the load step-up event actually occurs, and the controller is configured to adjust the third voltage level in response to the load step size.

16. A control method of a switching converter, comprising:
providing an output voltage of the switching converter;
receiving a load event signal;
detecting a plurality of voltage ranges of the load event signal; and
in response to the load event signal indicating that a load step-down event is about to occur, decreasing the output voltage from a first voltage level to a second voltage level before the load step-down event actually occurs; wherein
the load step-down event is an event that when a load current drawn by a load decreases.

17. The control method of claim 16, further comprising:
receiving a data which determines the first voltage level.

18. The control method of claim 16, further comprising:
recognizing a load step size from the load event signal, wherein the load step size indicates a degree of variation in the load current drawn by the load; and
adjusting the second voltage level in response to the load step size.

19. The control method of claim 16, further comprising:
in response to the load event signal indicating that a load step-up event is about to occur, increasing the output voltage from the first voltage level to a third voltage level before the load step-up event actually occurs; wherein
the third voltage level is adjusted in response to a load step size which indicates a degree of variation in the load current drawn by the load, and the load step-up event is an event that when a load current drawn by the load increases.

20. The control method of claim 16, further comprising:
providing a reference voltage based on a setpoint of the output voltage and the load event signal; wherein
the reference voltage is decreased in response to the load event signal indicating that the load step-down event is about to occur, and the reference voltage is increased in response to the load event signal indicating that a load step-up event is about to occur.
